(19) United States
(12) Patent Application Publication
(10) Pub. No.: US 2007/0129976 A1
(43) Pub. Date: Jun. 7, 2007

(54) Apparatus and methods for process and project management and control

(75) Inventors: Alon Hochberg, Ramat Aviv (IL); Vladimir Morgenstern, Framingham, MA (US)

Correspondence Address: DAVIDSON, DAVIDSON & KAPPEL, LLC, 485 SEVENTH AVENUE, 14TH FLOOR, NEW YORK, NY, 10018, US

(73) Assignee: Prolify Ltd., Netanya (IL)

(21) Appl. No.: 10/551,353

(22) PCT Filed: Aug. 4, 2005
(86) PCT No.: PCT/IL05/00833

§ 371 Date: Jan. 8, 2007

(51) Int. Cl. G06F 9/44; G05B 19/418

(52) U.S. Cl. 705/7; 705/8

(57) ABSTRACT

An apparatus and method for project or process management and control. The apparatus and method are based on detailed task information, as obtained from miscellaneous sources, especially e-mail and other personal productivity tools. The apparatus and method create tasks and processes relevant for a project and provide real-time status information, analysis and additional derived tasks. The method is enabled by representing all the project-related information in a uniform way, such as a project map, and the usage of patterns of different types to represent all the knowledge about a task, a sub-project, or a project. The system identifies known patterns in the project map, adds derived actions, analyzed risky situations and generated notifications and alerts.

### BACKGROUND OF THE INVENTION

1. Field of the Invention

The present invention relates to an apparatus and methods for project or process management in general, and to an apparatus and methods for defining, tracking and controlling the execution of processes or projects in particular.

2. Discussion of the Related Art

Projects and tasks in modern organizations involve ever growing number of people, documents and document types, computing platforms, environments, technologies and numerous other factors. Many projects involve multiple workers from various departments within an organization, or even different organizations, who use different tools and may reside in the same or different geographic locations. The need to adapt to dynamic and ever-growing requirements and environments result in frequent and often unplanned changes introduced to the processes, while the organization is still expected to meet its goals, by delivering the output on time, on budget, and in acceptable quality. The projects vary in scope from the simplest, such as updating a document, through intermediate, such as a change request in a product or testing a new version of a product, to highly complex tasks, such as merging companies. However, many problems are common to projects of all disciplines and all order of magnitudes. These problems include, but are not limited to: addition of unplanned activities to a project, and lack of control over such activities; addition of constraints or limitations, lack of real-time visibility into detailed process activity, and thus lack of real-time assessment of the status of the project; insufficient propagation of output and problems, causing suboptimal performance and difficulties in performing ongoing and up-to-date risk analysis; contradicting tasks; contradicting resource allocation; insufficient resources and the like. Even when projects are completed successfully, tedious control is required, and a lot of time and effort is spent over trivial tasks.

Currently available projects management tools attempt to address some or all of these problems. Some tools relate to project time and resource allocation, such as building a Gantt chart, other products offer document control, yet other products offer specific support for specific tasks, while additional products relate to other aspects of complex projects. Some tools are too simplistic, thus supporting only standard daily tasks, while others are intended for more complex tasks, but are therefore more specific and do not provide enough versatility in the handled tasks.

However, none of these tools provide a full solution to flexible uniform definition, controlling and tracking of all sorts and sizes of projects. In addition, these tools impose heavy burden on users, in the form of additional work required to update the relevant data, in order to keep the system up-to-date and thus meaningful.

There is therefore a need in the art for a system that will support the initial definition or creation of projects, enable the tracking and control over the progress of a project, support on-going changes and updates in resources such as personnel, equipment or other resources, supply the required documents necessary for tasks to the relevant people, and generate status or alert notifications on a regular basis or according to user definitions. The system should be integrated and work with currently available, as well as future working environments with minimal or no extra work on the user's side.

### SUMMARY OF THE PRESENT INVENTION

It is an object of the present invention to provide a novel method and apparatus for defining, tracking and controlling the execution of processes or projects. In accordance with the present invention, there is thus provided a method for constructing, controlling or managing a process, the method comprising the steps of: transforming one or more user events into one or more blocks of uniform presentation, and updating a project map with the uniform presentation block using one or more patterns. The method can further comprise the step of generating one or more actions. The actions can be assigned or notified to one or more users. The method can further comprise the steps of: converting user data into one or more user events; and converting the one or more actions into one or more messages. The method can further comprise the steps of capturing data provided by a user, and sending the messages to one or more users. The uniform presentation can be a graph presentation and the project map can be a project graph. Within the method the project graph may comprise one or more nodes or one or more arcs. The node or the arc can comprise relevant information. Within the method, a node can represent one or more persons, tasks or documents, and the arc can represent relationship or function between two nodes. Within the method the one or more blocks of uniform presentation can be one or more event graphs. Within the method, the step of updating the project map can comprise the steps of: a. adding the event graph to the project graph; b. determining whether the at least one event graph has common nodes with the project graph, and if so determining an impact of the at least one event graph on the project graph; c. for each of the at least one pattern, performing the steps of: determining whether the one or more patterns are found within the event graph and if a pattern is found within the project graph, merging the pattern with the graph; d. if a pattern was found within the project graph, performing the steps of: determining an impact of the event graph on the project graph; and if step d. is performed less than a predetermined number of times, repeating steps c. and d. Within the method the one or more user events can be any of the following: creating a new task, initiating a change request, creating an at least one project; adding an at least one task to an at least one project; assigning an at least one task to an at least one person; updating an at least one document; accepting an at least one task; rejecting an at least one task, reassigning at least one task; creating a subtask; or reporting task progress or completion. Within the method the pattern can be any of the following: change request; installation; hardware procurement; software procurement; module testing; prepare testing environment; system test design preparation; or system test plan preparation. Within the method the action can be any of the following: notification of an at least one completed task; notification of one or more rejected tasks; notification of one or more updated documents; assignment of one or more tasks to one or more persons; or notification of one or more risky situations.

Another aspect of the disclosed invention relates to an apparatus for controlling or managing a process, the apparatus comprising: a project graph comprising map data and a map handling component, a synthesis engine for updating the project graph with one or more event graphs; a conversion component for converting one or more event graphs to or from one or more actions or events, the conversion component comprising a first component for converting one or more events to one or more event graphs and a second component for converting one or more event graphs to one or more actions. Within the apparatus, the project graph can comprise one or more nodes or one or more arcs, the nodes or the arcs can comprise relevant information. The nodes can represent one or more persons, one or more tasks or one or more documents, and the arcs can represent relationship or function between two nodes. The apparatus can further comprise a component for converting one or more messages to or from one or more user actions or one or more events, the component comprising: a first component for converting one or more messages into one or more events and a second component for converting one or more actions into one or more messages. The apparatus can further comprise one or more e-mail interface components, for interfacing with one or more e-mail programs. One or more e-mail messages associated with the apparatus can comprise one or more tokens recognized by one or more e-mail program. The e-mail message associated with the apparatus can comprise a header and the token can comprise one or more identifiers embedded in the header. The e-mail message associated with the apparatus can comprise a body and the token can comprise one or more tags embedded in the body. The apparatus can further comprise an interface component for interfacing with one or more external tools, the interface component can comprise any one or more of the following: one or more productivity tool interface components for interfacing with one or more productivity tools; one or more handheld device interface components, for interfacing with one or more handheld devices; one or more document control interface components, for interfacing with one or more document control system; an interface wizard component, for generating one or more interfaces to one or more tools or devices or programs. The apparatus can further comprise one or more communication components for communicating one or more components within the apparatus with one or more second components within the apparatus, or one or more components within the apparatus with one or more tools or devices or programs. The apparatus can further comprise one or more security components for providing or restricting one or more privileges to one or more users or to one or more tasks or to one or more projects associated with the apparatus. The apparatus can further comprise one or more user interface components for collecting data from or showing data to one or more users of the apparatus. The apparatus can further comprise one or more diagnostics components for monitoring the apparatus, or one or more administration components for administrating the apparatus.

Yet another aspect of the disclosed invention relates to a computer readable storage medium containing a set of instructions for a general purpose computer, the set of instructions comprising: a project graph, the project graph comprising map data and a map handling component; a synthesis engine for updating the project graph with one or more event graphs; a conversion component for converting one or more event graphs to or from one or more actions or one or more events, the conversion component comprising: a first component for converting an event to one or more event graphs; and a second component for converting event graphs to one or more actions.

### BRIEF DESCRIPTION OF THE DRAWINGS

The present invention will be understood and appreciated more fully from the following detailed description taken in conjunction with the drawings in which:

FIG. 1 is a schematic block diagram of the main components of the apparatus, in accordance with a preferred embodiment of the disclosed invention;

FIG. 2 is a flowchart detailing the main steps of the method, in accordance with a preferred embodiment of the disclosed invention;

FIG. 3 is a flowchart of the main steps taken by the synthesis engine, in accordance with a preferred embodiment of the disclosed invention;

FIG. 4 shows an example of patterns, in accordance with a preferred embodiment of the disclosed invention; and

FIG. 5 shows an example of searching for a pattern within a graph, in accordance with a preferred embodiment of the disclosed invention;

FIG. 6 shows the graph of FIG. 5 with additional notification events, in accordance with a preferred embodiment of the disclosed invention; and

FIGS. 7A, 7B and 7C show examples of risky situations, in accordance with a preferred embodiment of the disclosed invention.

### DETAILED DESCRIPTION OF THE PREFERRED EMBODIMENT

The following definitions are provided so as to enable a better understanding of the present invention:

Node—a graph element, representing a person, a task, a document.

Arc—a connection between nodes, representing functions or relationship between the entities represented by the nodes. Each arc carries a type and attributes, which differentiate it from other arcs connecting the same nodes.

Map Object—an arc or a node. Each object carries all the relevant properties.

Process map—a collection of map objects that represents a process.

Pattern—a predefined sub-process map, generally used as a building block of a process map.

Event—a user activity that fits a specific basic pattern (e.g., approve task, change process document).

Event graph—a collection of map objects that represents a specific event.

Impact (of an event on a process map)—event graph objects that do not yet exist in the process map.

Action—system initiated activity (e.g., a notification, a proposed activity)

The present invention overcomes the disadvantages of the prior art by providing a novel system and methods which improve on the currently available tools for defining, tracking and control of projects. The apparatus of the present invention comprises a project graph; a synthesis engine and a conversion component. The apparatus is project-oriented, using a structure of sub-projects and tasks represented by blocks of a uniform presentation as the building blocks of projects. The projects and tasks definitions are dynamic, and each project can, at any stage, be expanded by more sub-projects or tasks, and each task can be expanded into a project. This way, the project is constructed and the relevant information, such as the status, the risky factors and other data is obtained bottom up, i.e., from the smallest units to the overall picture. The apparatus is seamlessly integrated into and makes use of productivity tools, such as e-mail systems, electronic charts, databases and others. Behind the scenes, the project, tasks and the like are uniformly represented. This presentation can take various forms, one of which is a graph, comprising nodes and arcs. Each presentation method, graph included, can be implemented using various data structures and algorithms. When using graphs as a representation method, the project is modeled as a project map, whose nodes represent people, tasks or documents, and whose arcs represent connections among the abovementioned entities. Each node or arc contains all the relevant information. For example, a node representing a task comprises due date, an arc connecting two people comprises information related to the hierarchy between them, an arc connecting a person and a task carries a risk level, and the like. This presentation gathers all process-related information into one model containing all relevant information, thus enabling computer based control over a project. Additionally, the map structure enables dynamic update of the tasks, by addition, updating, reporting completion, rejecting and the like. The map also enables an up-to-date status report on a project, what tasks are currently performed, which are suspended until a condition is met, what are the risky points in the process and others. During installation, the apparatus is plugged-in into the productivity tools, so that information relevant to a project can be efficiently extracted form the tools. For example, clicking on a designated button in any of these tools attaches the relevant entity, such as a document, an e-mail or the like into an existing or a newly-created project, and according to the context creates or updates a new project, sub-project or task. An entity is defined as an object related to the process, project, task, or other elements of the method and apparatus of the present invention, such as a document, file, person, task, organization and the like. This addition or update causes an update and impact assessment of the map, causing in turn alerts and more tasks identified by known behavioral patterns to be generated and propagated. A pattern can therefore represent a known behavior, a business rule such as if-then situation (when a certain pattern is found, another pattern should be added to the map), a risk pattern (a situation recognized as risk to the process) which might require issuing notifications, or another behavior. The behavior can be either general, or domain-specific, such as a change request in a software project, which necessitates a task of quality assurance, even if such task was not explicitly created by the user. Other examples for patterns are installation, hardware procurement, software procurement, module testing, preparing a testing environment; system test plan (STP) preparation, or system test definition (STD) preparation.

The quality assurance task is created by the system, upon identifying a pattern in the graph that suits a change request, and relevant tasks are derived from it. Patterns represent behaviors of basic entities and activities, aggregate activities, definition rules and policies, and process models and best practices. Other patterns are, for non-limiting examples, process steps, task breakdown, workflow next step, business rule, a template or a risk pattern. Patterns are used for all types of projects, ranging from the simplest, such as a request to update a document which does not have any implications, via intermediate, possible domain specific projects, such as releasing a new version of a project, to highly complex projects, such as developing and marketing a new product.

Patterns can be explicitly created by user activities indicated as being of a known type. Alternatively, patterns are implicitly detected by the system recognizing sub-graphs in the project graph as representing a pattern. In the latter case, the system can generate activities related to the pattern. An initial pattern library is a part of an installation of the apparatus, and additional types can be defined by a user. Periodically, or according to any defined schedule the system monitors the progress of the project, performs risk analysis and sends notifications. The system outputs information using the same channels as the input, i.e., e-mail messages, documents and the like. The update of the map and the impact assessment enable the dynamic tracking and control of projects, including timely reaction to changes, and the updated and reported risk assessment.

For a non-limiting usage example, a project starts by a user, creating a process, either explicitly or implicitly by sending an e-mail message assigning a task to another user. The user creates a new project or associates the message with an existing project, selects a task type and enters the relevant information, such as due date, relevant documents or the like. The information within the message is transformed into an event, the event is transformed into an event graph, which is integrated with an existing or newly created project graph. The project graph is updated, and global impact is calculated. Then new tasks or sub-projects are recognized using existing patterns in the project graph, actions are possibly derived from the tasks, and messages relating to the tasks, to risky situations or the like are sent to the initiator or to other users. The disclosed invention relates to a computerized apparatus, comprising one or more computerized devices connected by a network, running a set of applications and exchanging information. Each computerized device is preferably a computing platform, such as a personal computer, a mainframe computer, or any other type of computing platform that is provisioned with a memory device, a CPU or microprocessor device, and several I/O ports. Alternatively, one or more of the computerized devices can be a DSP chip, an ASIC device storing the commands and data necessary to execute the methods of the present invention, or the like. Each device can further include a storage device (not shown), storing one or more applications or data used by any of the applications. Each application is a set of logically inter-related computer programs and associated data structures that interact to perform the objectives of the disclosed invention. In a preferred embodiment of the disclosed invention, the computerized devices comprise one or more server stations, running the synthesis engine applications, and one or more agent stations, running the applications that support the interfaces with the external components. The other components and applications can be run on the server stations or on the agent stations, depending on the resources and requirements related of each station, the desired distribution level, and similar considerations. In another preferred embodiment, there is no sharp distinction between servers and agents, and each task can be performed on one or more stations.

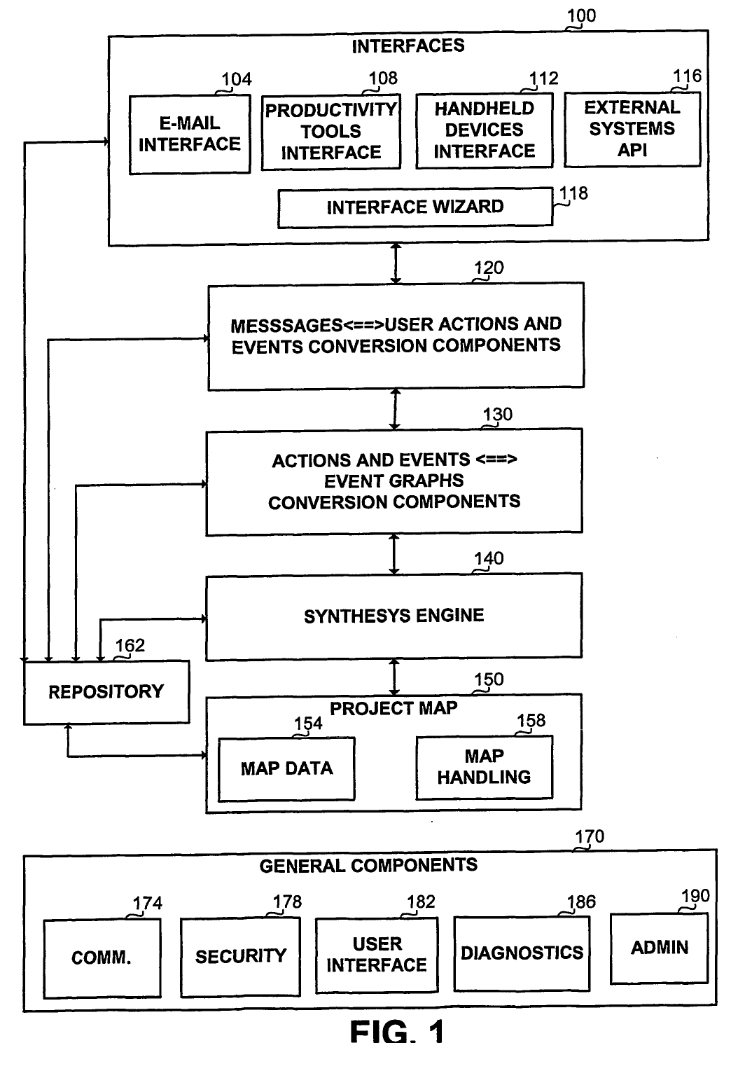

Referring now to FIG. 1, showing the main components of computer applications associated with the disclosed invention. Interfaces component 100 is responsible for interacting with personal productivity tools and systems external to the disclosed invention. Some of these interfaces, such as e-mail interface 104 provide a high degree of integration, by installing the relevant application as a plug-in of the relevant system. For example, in e-mail interface 104, a button is added to mail message generated by the mailing program (such as Outlook by Microsoft), which converts a regular e-mail message sent from one person to another into a task which the first person assigns to the second person. The task can be associated with an existing project or a new project. All interfaces capture data from the relevant systems, and deliver data back to the systems, for example by generating and sending e-mail messages comprising automatically generated tasks, alert and risk notifications and the like. Since e-mail is a major tool used in workflow management and control, there is extensive integration of the system with e-mail programs. A token marking an e-mail messages as belonging to a project, is attached to the message, and enables the passing, interpretation, and presentation of the message as such. When the message arrives to a user who has not installed the system, the token is ignored and the message is ordinarily represented, but if a derivative, such as a reply, or a forward of the message is sent to a user of the system, the token is recognized and the message resumes its looks as a message associated with a project. The token is implemented as an identifier embedded in the e-mail header which allows agents (mail programs) to recognize e-mails as relating to the system, and presenting them as such. The relevant information can be embedded within the e-mail using tags, such as XML tags. Interfaces 100 further comprise interfaces to other productivity tools 108, such as interfaces to a database program, an electronic spreadsheet program and the like. Yet another type of interfaces is handheld devices interface 112, which connects to handheld devices such as a palm, a Blackberry or the like. Interfaces 100 further comprise APIs for the interface with other systems, such as document management systems like Sharepoint, Mercury's Quality Center and others. It will be appreciated by persons skilled in the art that other interfaces to currently known systems, devices, machines and other entities currently known or that will become known at a later time may exist. For this end, interface wizard 118 is a component that enables easy integration with other systems, provided these systems supply an external interface. The apparatus further comprises a messages user actions and events two way conversion components 120. This component is responsible for transforming the user actions, such as sending an e-mail into system events on one side, and for the opposite action, of transforming system events, for example events that were generated automatically by recognized patterns into actions such as e-mails, updating a database or the like. Another computerized component is actions and events and event graphs two way conversion component 130, responsible for converting an event, such as “update document” task assigned by one person to the other, into a sub graph. The nodes participating in the graph are the relevant persons, the task and the document. The other aspect of this component relates to the inverse transformation, from automatically generated event graphs, related to newly created tasks or notifications into events, which are then transformed by messages user actions and events conversion components 120 into actions. Synthesis engine 140 is responsible for the logic within the system, including maintaining the overall structures and activities relating to one or more projects, updating the activities, issuing notifications and the like. Synthesis engine 140 communicates with project map 150, which comprises a data structure representing the map 154, and map handling component 158 for performing actions on map 154, such as searching for known patterns on the map, unifying graphs, identifying conflicting activities in the graph and other activities. All the above mentioned components use repository 162, comprising the known patterns, available task types, and other data required by the system. The system further comprises general components 170, which connect to all or most of the other components of the system. General components 170 comprise communication components 174, responsible for connecting the elements of the apparatus and transferring messages form sources to destinations. One group of communication elements interfaces with the components by enabling the sending and receiving of messages via an input queue and an output queue. The other group of elements is a set of services which transfer the messages, each service using a different transport method, such as E-mail, HTTP POST, HTTP OK, and the like. General components 170 further comprise a security component 178, for enforcing a security policy as defined by a user. The security policy controls the privileges granted to each entity to view and act certain projects or project types. Yet another general component is user interface set of components 182 which generates and activates the user interface for all parts of the apparatus that have to output data visually. The user interface comprises, for example a task management form, a process map drill-down presentation, a personal dashboard or the like. Yet another component is diagnostics component 186 which enables a user to monitor the behavior of the apparatus, including parameters as performance, correctness of actions and the like, and administration component 190 for defining the rules, policies, patterns, users, relationships, privileges and additional entities in the apparatus.

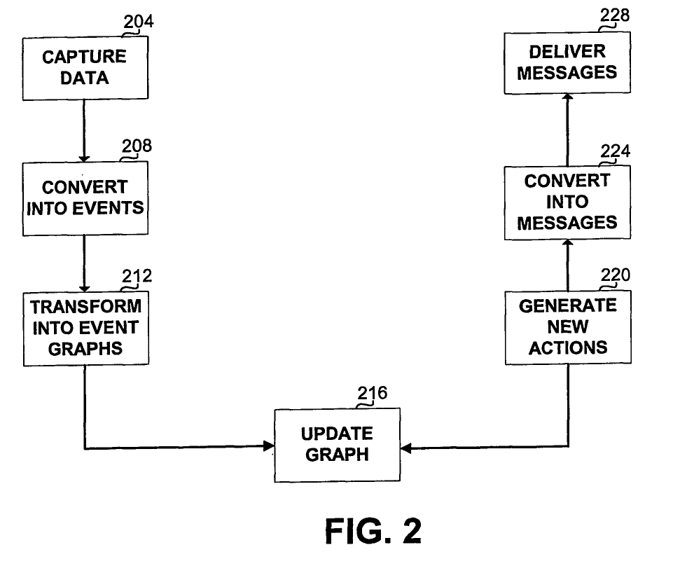

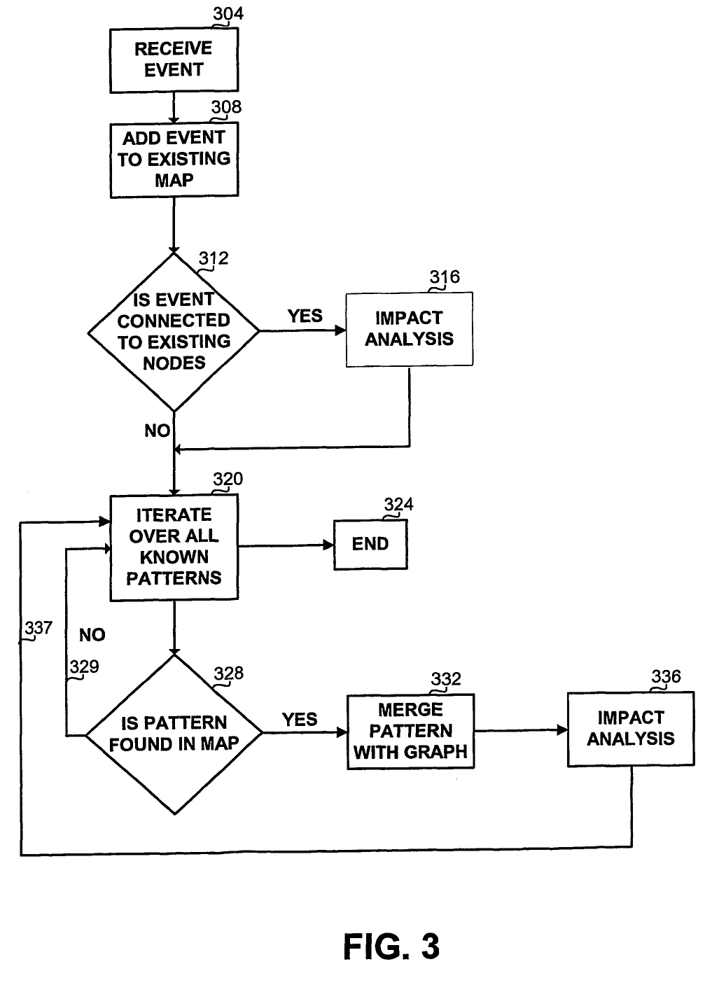

Referring now to FIG. 2 showing the main steps associated with the proposed method. The method is preferably event-triggered, i.e., user activities initiate system activity, updated, initiation of processes and the like. In addition, certain activities are initiated according to predetermined schedules. The following chain of events happens following each user activity. The user activities can relate to existing projects, new projects, new events, addition of events, completing a task which enables people waiting for the output of the task such as a document, to proceed, or the like. At step 204, data is captured from a user, using any of the interfaced tools shown as components 100 of FIG. 1. At step 208 the user input is converted into a specific event, such as creating a new task, initiating a change request, creating a project, adding a task to a project, assigning a task to a person, updating a document; accepting a task, rejecting a task or the like. The event is associated with an existing project, or the user can initiate a new project through this event. At step 212, the event is transformed into an event graph, representing the participating entities, i.e. the involved people, the task and the associated documents or files. The transformation is preferably performed by retrieving a pre-prepared template or an example of an event graph which is suitable for the event, from a collection of templates, and assigning the relevant entities, such as persons, tasks, documents or the like to the nodes, and the relevant relationships to the arcs. At step 216 the graph is updated with the new event, and the impact is calculated. This step is further detailed in association with FIG. 3 below. At step 220 new actions are possibly derived from the change in the map, such as notification of a completed task, notification of a rejected task, notification of an updated document, assignment of a task to a person, notification of a risky situation, or the like. Since these actions are derived from updates to the graph initiated by the system, they are consistent with action types that exist in the system. At step 224 the actions are transformed, for example into messages to be sent to the relevant entities, again by transforming an action into a pre-prepared e-mail message, file or another entity, using parameters associated with the action. At step 228 the messages are sent to the relevant entities. When considering FIG. 2 in a horizontal division, it is seen that steps 204 and 228, which are associated with messages are performed by interface components 100 of FIG. 1; steps 208 and 224 which handle the conversion between actions or events and messages are performed by messages user actions and events two way conversion components 120; and steps 212 and 220, which convert between event graphs and actions or events are performed by actions and events two way conversion components 130. Step 216 is performed by synthesis engine 140.

Referring now to FIG. 3, detailing the main steps in the activity of synthesis engine 140 of FIG. 1, which is step 216 of FIG. 2. It should be appreciated that other methods, which may include one or more of the suggested steps, may be designed to suitably perform the concepts of the present invention in other similar manners. Such alternative methods and modes are also covered by the present invention. At step 304 the event graph is received by the synthesis engine. At step 308 the event graph is added to the existing map. At step 312, the engine checks whether the event is connected to an existing node, i.e. the event relate to an entity already participating in the graph, for example a common person, document or the like. If the event is indeed connected, the impact of the addition on the graph is calculated at step 316. The impact is the merging of the graph elements of the event graph and the existing graph. After the impact analysis, or without performing the analysis of there is no connection between the event graph and the project graph, the system starts iterating over all known patters at step 320. For each pattern, at step 328 it is checked whether this pattern can now be found in the updated merged graph. For example, once the event is a design document completed by a person, the pattern of “document completed” is found, possibly in more than one place if multiple tasks depend on this document. If the pattern is not found in the map, the system continues at step 329 to check the next pattern. If all patterns were checked and no pattern is found the process ends at step 324. If a pattern is found, it is merged with the graph at step 332. Then the next pattern is searched for, and merged if found at step 329. Once all patterns are found and merged, impact analysis is performed at step 336, which is similar to step 316. At step 337, the system checks whether the graph was changed by impact analysis step 336. If the graph was not changed, the process ends at step 338. Otherwise the system goes back to step 320 and restarts iterating over all patterns. The process repeats until no change occurs to the graph. At this stage, all the calculated impacts, representing newly created actions are processed, as was explained in association with FIG. 2 above. In addition, predetermined number of iterations, such as five, is defied, and once the number of iterations is completed, the system halts. It will be appreciated by persons skilled in the art that other methods for updating and maintaining a project can be designed to obtain the objectives of the present invention, as long as the steps comprising: adding an event; calculating the impact of the event on the project; and updating the project presentation, are performed.

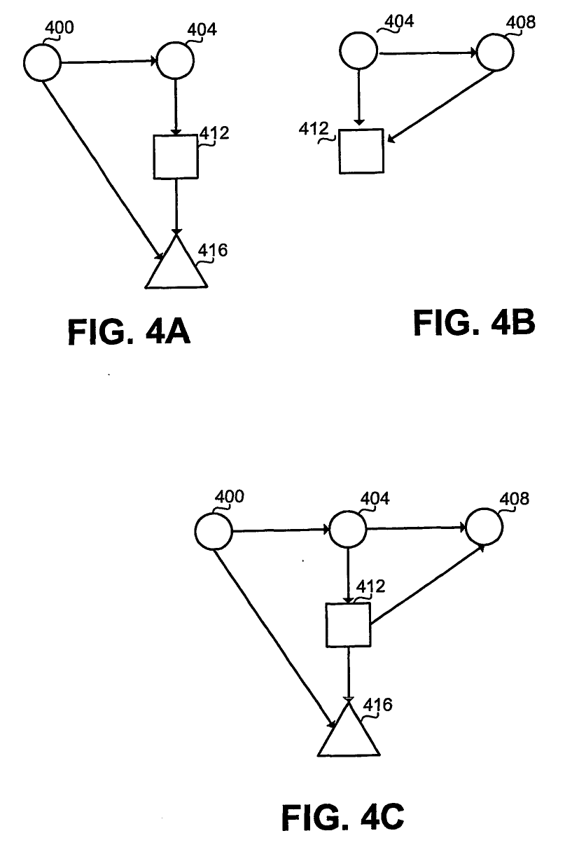

Referring now to FIG. 4, which shows an example of map construction. In FIG. 4, people are denoted by circles, tasks are denoted by squares and documents are denoted by triangles. FIG. 4A represents person 400 assigning task 412 to person 404, where task 412 is associated with document 416. FIG. 4B shows a representation of the event when person 404 further assigns the task to person 408. FIG. 4C shows the combined graph when common elements are merged. Due to the connections between the elements, containing information about the relationships, once the task is completed by person 408, the system will generate notifications either to person 404 alone, or to both persons 404 and 400. according to the notification policy pattern detailed below.

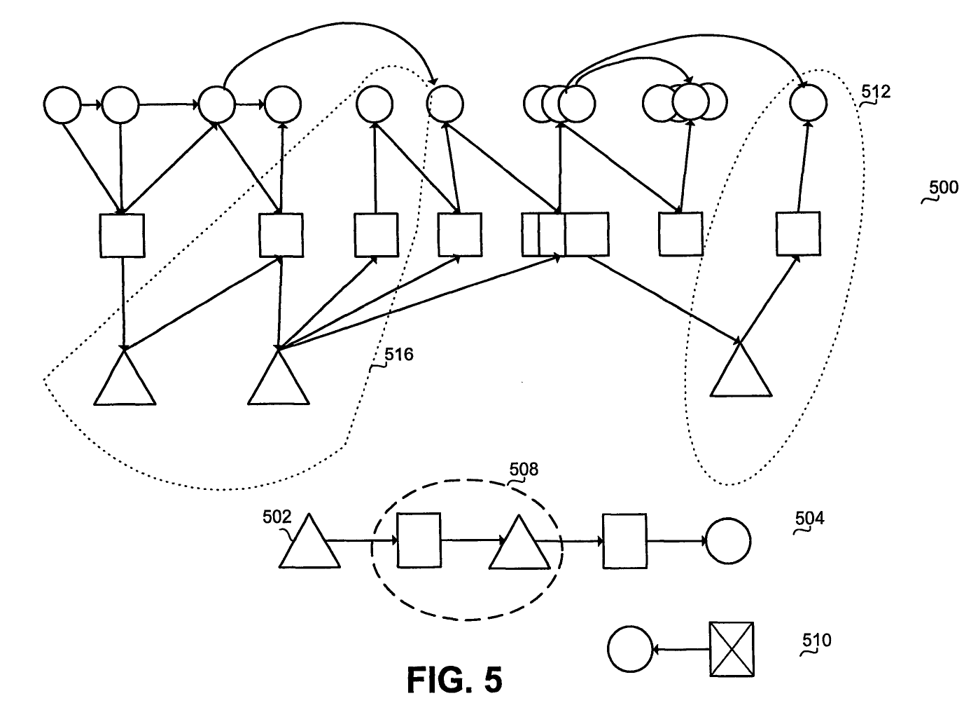

Referring now to FIG. 5, which shows an example for finding and applying a pattern within a graph. Process graph 500 is a development of the graph shown in FIG. 4C, which developed as task 412 was executed, document 416 was changed, and other related tasks and people were affected. Pattern 504 is one of the applicable patterns to be searched for, and pattern 510 is to be activated when pattern 504 is identified. In process terms, pattern 510 represents a notification, such as an action to be taken when an occurrence of the condition represented by pattern 504 is identified. In the case of graph 500, pattern 510 which represents a notification, explicitly instructs the system that when document 416 or another document associated with tasks associated with document 416 (hereinafter “the relevant tasks”) are updated, all people who are working on the relevant tasks should be notified. The square representing the action of pattern 510 is visually marked different than the squares representing other actions in graph 500, in order to highlight its nature of “notification”. The encircled area within pattern 504, denoted by 508 represents a sub-pattern which can repeat any number of times, including 0, 1, 2 and so on. Pattern 504 is found in graph 500 in multiple places. For clarity reasons, only two of them are encircled in FIG. 5. The first is 512 in which an area equivalent to 508 appears exactly once, and area 516 in which sub-area 508 appears twice.

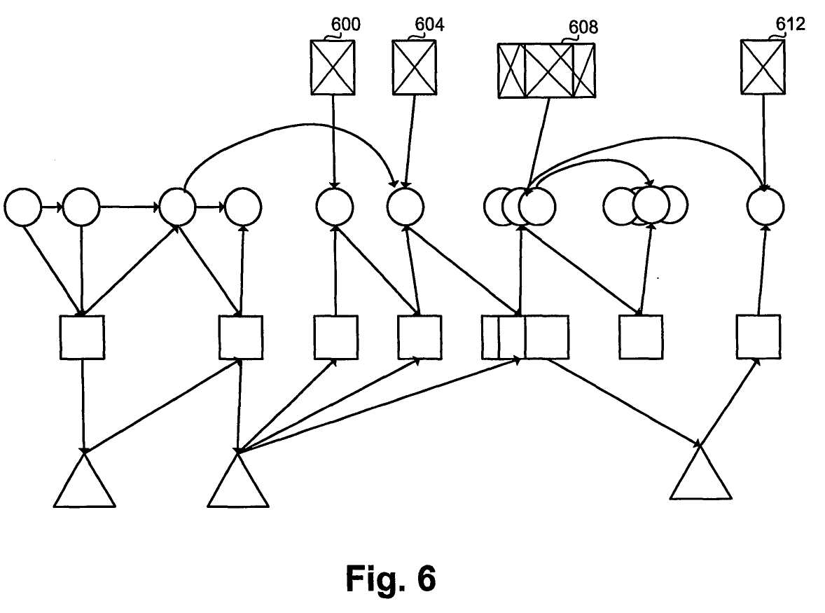

FIG. 6 shows notification actions 600, 604, 608, and 612 which were added to the graph as a result of the identified pattern. When a certain task is completed, or for example rejected due to missing resource, the results are propagated to all relevant people and action can be taken immediately. For reasons of efficiency, pattern 504 can be considered in two stages: first, finding whether the document at the left-hand side of the pattern, denoted by 502, has changed, and if so, is the rest of the pattern applicable. The graph presentation also enables the notification of contradicting or otherwise impossible situations, such as a task being assigned to person A and the task's completion is reported by person B, multiple people reporting the creation of the same document or the like. This is possible since a real object can have multiple instances in a map, so that multiple different and even contradicting relations can exist, which involve different instances of the same object. Such a situation is recognized as a risk, either pre-defined or a user-defined pattern-based risk (represented by a pattern). Each risk carries a weight, i.e., a potential impact, and probability indicator which is used in overall risk calculations. Once risk reaches certain (configurable) level, action will be invoked by appropriate pattern.

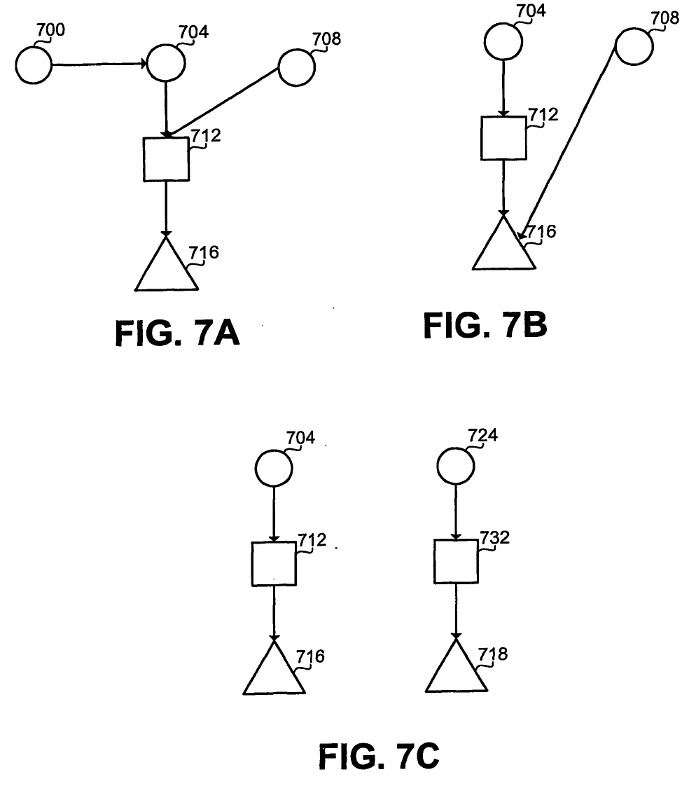

Reference is now made to FIGS. 7A, 7B and 7C, showing examples for contradictions. In FIG. 7A, person 700 assigns task 712 to person 704, while person 708 reports completion of the same task. In FIG. 7B, person 704, as part of task 712, works on document 716, while person 708 announces release of document 716. In FIG. 7C, person 704 works on a certain version of document 716 while person 724 works on document 718 which is a different version document 716. The information carried by arcs, including type and attributes is essential to representing different situations. Two instances of the same topological graph, wherein topologically-identical arcs have different types or attributes are different, and different patterns are applicable to them. Therefore, a graph with certain nodes and arcs can represent a risk less situation, while an identical graph, with different arc types will represent a conflict. The system will recognize conflict situations and will validate them with the person who created the conflict through notification, but it is possible for the user to force the conflict and treat it as a risk. When the risk is significant enough, i.e., its weight is beyond a predetermined threshold, the system will try to resolve the situation with the second person involved.

The graph operations, such as finding the patterns, merging graphs and the like are implementations of well known graph theory techniques and algorithms. As a non-limiting example, the pattern matching can be performed using BFS search with relaxation parameter to ensure convergence of the algorithm.

The graph is stored internally in any appropriate data structures and formats, such as a relational database, an object-oriented database, or the like.

The disclosed invention provides a versatile apparatus for computer-based process control. The apparatus integrates with existing tools, and using it does not introduce a significant amount of additional burden for the user. The system propagates risky situations, thus enabling early alert and efficient handling. The invention shows that using a relatively small number of standard steps enables control over complex projects.

Persons skilled in the art will appreciate that many options and possibilities exist in the system. The infrastructure can be implemented in many ways, such as conceptual division of the components into layers, modules, or other methodologies, using various protocols for communicating with external resources and for message passing, integrating additional tools into the system, different client-server separation, and the like. The system can be integrated with many external tools, relating for example to user interface, security, information services and the like.

The core of the system, i.e., the model, or the graph can also be implemented in various ways, including both the data structures and the associated algorithms. Many types of patterns, tasks and projects can be introduced into the system, where some of them are general such as “update document”, or “arrange a meeting”, while others are more specific and can be tailor-made by or for the customer. The capability of automatically learning new patterns can be introduced into the apparatus, thus supporting the recognition and usage of new patterns implicitly and without additional burden.

It will be appreciated by persons skilled in the art that the present invention is not limited to what has been particularly shown and described hereinabove. Rather the scope of the present invention is defined only by the claims which follow.

What is claimed is:

1. A method for constructing, controlling or managing a process, the method comprising the steps of:
transforming an at least one user event into an at least one block of uniform presentation; and
updating a project map with the uniform presentation block using an at least one pattern.

2. The method of claim 1 further comprising the step of generating an at least one action.

3. The method of claim 2 wherein the at least one action is to be assigned or notified to an at least one user.

4. The method of claim 2 further comprising the steps of:
converting user data into the at least one user event; and
converting the at least one action into an at least one message.

5. The method of claim 4 further comprising the steps of:
capturing data provided by a user; and
sending the at least one message to an at least one user.

6. The method of claim 1 wherein the uniform presentation is a graph presentation.

7. The method of claim 6 wherein the project map is a project graph.

8. The method of claim 7 wherein the graph presentation comprises an at least one node or an at least one arc.

9. The method of claim 8 wherein the at least one node or at least one arc comprises relevant information.

10. The method of claim 8 wherein the at least one node represents an at least one person, an at least one task or an at least one document.

11. The method of claim 8 wherein the at least one arc represents relationship or function between two nodes.

12. The method of claim 8 wherein the at least one block of uniform presentation is an at least one event graph.

13. The method of claim 12 wherein the step of updating the project graph comprises the steps of:
a. adding the at least one event graph to the project graph;
b. determining whether the at least one event graph has an at least one common node with the project graph, and if so determining an impact of the at least one event graph on the project graph;
c. for each of the at least one pattern, performing the steps of:
determining whether the at least one pattern is found within the event graph; and
if the at least one pattern is found within the project graph, merging the at least one pattern with the graph;
d. if an at least one pattern was found within the project graph, performing the steps of determining an impact of the at least one event graph on the project graph, otherwise end the process; and
if step d. is performed less than a predetermined number of times, repeating steps c. and d.

14. The method of claim 1 wherein the at least one user event is any of the following: creating a new task; initiating a change request; creating an at least one project; adding an at least one task to an at least one project; assigning an at least one task to an at least one person; updating an at least one document; accepting an at least one task; rejecting an at least one task; reassigning at least one task; creating a subtask; reporting task progress or completion.

15. The method of claim 1 wherein the at least one pattern is any of the following: change request; installation; hardware procurement; software procurement; module testing; prepare testing environment; system test design preparation; system test plan preparation.

16. The method of claim 2 wherein the at least one action is any of the following: notification of an at least one completed task; notification of an at least one rejected task; notification of an at least one updated document; assignment of an at least one task to an at least one person; notification of an at least one risky situation.

17. An apparatus for controlling or managing a process, the apparatus comprising:
a project graph, the project graph comprising:
map data; and
a map handling component;
a synthesis engine for updating the project graph with an at least one event graph;
a conversion component for converting an at least one event graph to or from an at least one action or an at least one event, the conversion component comprising:
a first component for converting an at least one event to an at least one event graph; and
a second component for converting an at least one event graph to an at least one action.

18. The apparatus of claim 17 wherein the project graph comprises an at least one node or an at least one arc.

19. The apparatus of claim 18 wherein the at least one node or the at least one arc comprises relevant information.

20. The apparatus of claim 18 wherein the at least one node represents an at least one person, an at least one task or an at least one document.

21. The apparatus of claim 18 wherein the at least one arc represents relationship or function between two nodes.

22. The apparatus of claim 17 further comprising a component for converting an at least one message to or from an at least one user action or an at least one event, the component comprising:
a first component for converting an at least one message into an at least one event; and
a second component for converting an at least one action into an at least one message.

23. The apparatus of claim 17 further comprising an at least one e-mail interface component, for interfacing with an at least one e-mail program.

24. The apparatus of claim 23 wherein an at least one e-mail message associated with the apparatus comprises at least one token recognized by an at least one e-mail program.

25. The apparatus of claim 24 wherein the at least one e-mail message associated with the apparatus comprises a header and the at least one token comprises an at least one identifier embedded in the header.

26. The apparatus of claim 24 wherein the at least one e-mail message associated with the apparatus comprises a body and the at least one token comprises an at least one tag embedded in the body.

27. The apparatus of claim 17 further comprising an interface component for interfacing with an at least one external tool, the interface component comprising any one or more of the following:
an at least one productivity tool interface component for interfacing with an at least one productivity tool;
an at least one handheld device interface component, for interfacing with an at least one handheld device;
an at least one document control interface component, for interfacing with an at least one document control system;
an interface wizard component, for generating an at least one interface to an at least one tool or an at least one device or an at least one program.

28. The apparatus of claim 17 further comprising an at least one communication component for communicating an at least one component within the apparatus with an at least one second component within the apparatus, or an at least one component within the apparatus with an at least one tool or an at least one device or an at least one program.

29. The apparatus of claim 17 further comprising an at least one security component for providing or restricting at least one privilege to an at least one user or to an at least one task or to an at least one project associated with the apparatus.

30. The apparatus of claim 17 further comprising an at least one user interface component for collecting data from or showing data to an at least one user of the apparatus.

31. The apparatus of claim 17 further comprising an at least one diagnostics component for monitoring the apparatus.

32. The apparatus of claim 17 further comprising an at least one administration component for administrating the apparatus.

33. A computer readable storage medium containing a set of instructions for a general purpose computer, the set of instructions comprising:
a project graph, the project graph comprising:
map data; and
a map handling component;
a synthesis engine for updating the project graph with an at least one event graph;
a conversion component for converting an at least one event graph to or from an at least one action or an at least one event, the conversion component comprising:
a first component for converting an at least one event to an at least one event graph; and
a second component for converting an at least one event graph to an at least one action.
